(19) United States
(12) Patent Application Publication
(10) Pub. No.: US 2025/0390930 A1
(43) Pub. Date: Dec. 25, 2025

(54) ARTIFICIAL INTELLIGENCE (AI) AND ONLINE SHOPPING INTEGRATION

(71) Applicant: NCR Voyix Corporation, Atlanta, GA (US)

(72) Inventors: Jacob Regis Cronauer, Marietta, GA (US); Michael Jiang Tang, Alpharetta, GA (US); Kun Zhu, Smyrna, GA (US); Nik Teshima, Atlanta, GA (US); Nick Arlt, Atlanta, GA (US)

(21) Appl. No.: 18/753,296

(22) Filed: Jun. 25, 2024

(51) Int. Cl. G06Q 30/0601; H04L 51/02

(52) U.S. Cl. CPC G06Q 30/0633; G06Q 30/0631; G06Q 30/0641; H04L 51/02

(57) ABSTRACT

Methods and system is provided for enhancing online grocery shopping through an Artificial Intelligence (AI) Virtual Shopping Assistant integrated within retail online shopping or ordering platforms. User inputs in natural language are received, specifying shopping requests such as recipes or events along with any user desired conditions. The assistant processes these inputs, interacts with a chat bot to generate a preliminary list of items, and checks item availability against an online inventory. Fuzzy matching algorithms are processed which consider user and/or store-based preferences, store discount data, store price data, and inventory data to refine the item suggestions. The refined list is presented to the user for review, allowing modifications like additions, deletions, or substitutions. Confirmed items are automatically added to the user's online cart for checkout with the corresponding retail shopping or ordering platform providing seamless integration with the online platform.

### BACKGROUND

Online grocery shopping has experienced significant growth, driven by advancements in technology and changes in consumer behavior. Traditional online shopping platforms often require users to manually search and select each item, a process that can be time-consuming and prone to errors, such as forgetting essential ingredients. This inefficiency has created a demand for more intelligent and automated solutions. In response, various technologies have been developed to enhance the user experience, including virtual assistants and recommendation engines. However, these solutions often fall short in seamlessly integrating comprehensive meal planning and grocery shopping.

### BRIEF DESCRIPTION OF THE DRAWINGS

FIG. 1A is a diagram of a system for artificial intelligence (AI) and online shopping integration, according to an example embodiment.

FIG. 1B is a pictorial diagram depicting an example flow of the system, according to an example embodiment.

FIG. 2 is a flow diagram of a method for AI and online shopping integration, according to an example embodiment.

FIG. 3 is a flow diagram of another method for AI and online shopping integration, according to an example embodiment.

### DETAILED DESCRIPTION

Existing shopping technology, particularly for grocery platforms like Instacart® and Amazon Fresh®, exhibits significant deficiencies that impact user experience. These platforms typically require users to manually scroll through extensive product lists and individually add items to their shopping carts, a process that is both tedious and prone to errors, such as forgetting essential ingredients. Additionally, these systems lack integrated solutions for seamless recipe planning and grocery shopping, failing to offer personalized recommendations that fully consider individual preferences or specific dietary needs. Moreover, while some AI tools and virtual assistants provide product suggestions, they do not interact directly with retail systems to check or access real-time inventory data, place orders, or integrate with the retailer's checkout and scheduling systems, resulting in a fragmented and inefficient shopping experience.

Embodiments of the technology disclosed herein address these issues by providing a more integrated, efficient, and user-friendly solution that leverages advanced artificial intelligence (AI) capabilities to enhance the online grocery shopping experience. This includes automating the assembly of ingredients and/or items based on user-input recipes, items, or events, offering intelligent substitutions and modifications, and directly interfacing with retail systems or platforms for real-time inventory and order processing.

Techniques presented herein revolutionizes the online grocery shopping experience by integrating directly into retail store platforms. A containerized object or application is integrated into an existing online shopping user interface to provide a seamless AI virtual online shopping assistant to a user during an online shopping session. The AI virtual shopping assistant simplifies the process of building a shopping list by allowing users to input recipes, items, or event types, such as a Super Bowl® party, and automatically suggesting relevant ingredients and/or items along with their in-store prices. Users can review and modify the suggested list—adding, removing, or substituting items—before confirming the order, which is then seamlessly added by the AI virtual shopping assistant to a retailer's online cart associated with the retailer's online shopping user interface. The AI virtual shopping assistant leverages large language models for understanding user requests and employs fuzzy matching algorithms to align and/or refine these requests with available store inventory data, prioritizing based on store preferences or store preference data; user preferences or user preference data; and/or user transaction history or purchase history. This technique not only enhances the speed and convenience of shopping but also personalizes the experience, making it more engaging and efficient for users while providing retailers with a competitive edge in the online shopping market.

As used herein, a “consumer,” “customer,” and/or “user” can be used synonymously and interchangeable. This refers to an individual engaged in an online shopping session with an online shopping application of a retailer.

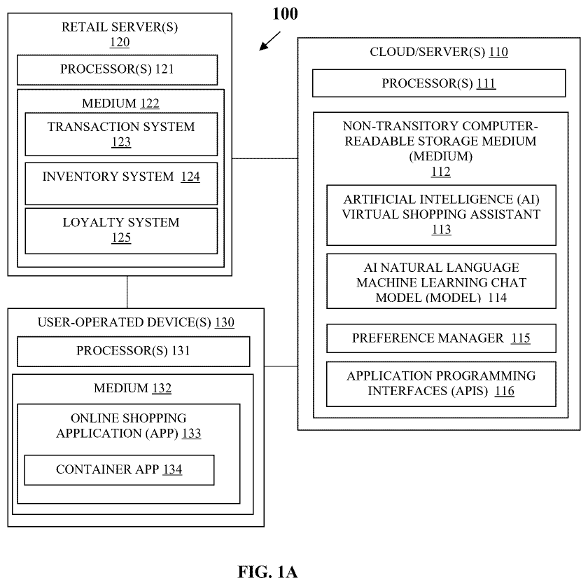

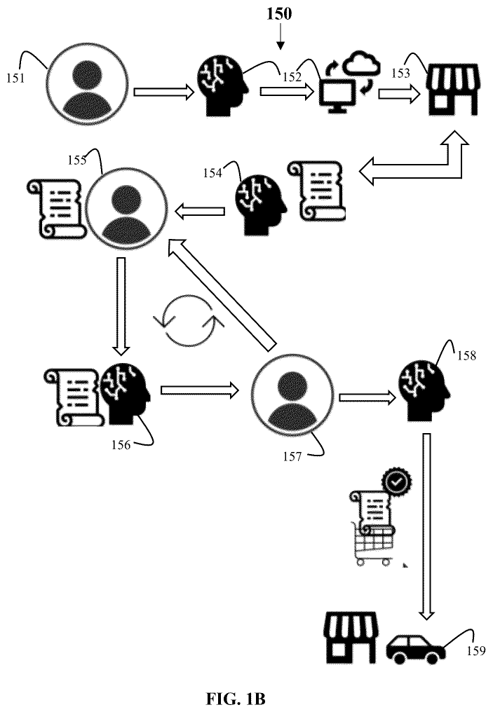

FIG. 1A is a diagram of a system 100 for AI and online shopping integration, according to an example embodiment. Notably, the components are shown schematically in simplified form, with only those components relevant to understanding of the embodiments being illustrated.

Furthermore, the various components (that are identified in system 100) are illustrated and the arrangement of the components are presented for purposes of illustration only. Notably, other arrangements with more or less components are possible without departing from the teachings of AI and online shopping integration, presented herein and below.

System 100 includes a cloud/server 110 (hereinafter “cloud 110”), one or more retail servers 120, and one or more user-operated devices 130. Cloud 110 includes at least one processor 111 and a non-transitory computer-readable storage medium (hereinafter “medium”) 112, which includes instructions for an AI virtual shopping assistant 113, an AI natural language machine learning chat model (hereinafter “chat model”) 114, a preference manager 115, and application programming interfaces (APIs) 116. The instructions when executed by processor 111 cause processor 111 to perform processing or operations discussed herein and below with respect to 113-116.

Each retail server 120 includes at least one processor 121 and a medium 122, which includes instructions for a transaction system 123, an inventory system 124, and loyalty system 125. The instructions when executed by processor 121 cause processor 121 to perform processing and operations discussed herein and below with respect to 123-125.

Each user-operated device 130 includes at least one processor 131 and a medium 132, which includes instructions for an online shopping application (hereinafter “app”) 133, which includes a container app 134. The instructions when provided to and executed by processor 131 cause processor 131 to perform the processing or operations discussed herein and below with respect to 133 and 134.

Initially, a self-contained processing environment is integrated into a given online shopping app 133 as a container app 134 or container object, which is callable from the user interface of the online shopping app 133. For example, the user interface (UI) includes a new and enhanced option for a user to perform online shopping with the corresponding retailer associated with the online shopping app 133. When the container app 134 is selected by the user via the UI, the container app 134 utilizes APIs 117 to interact with AI virtual shopping assistant 113 of cloud 110.

When the user selects the enhanced option from the UI of the online shopping app 133 during the session, a sub UI within a processing context of the UI for the online shopping app 133 is presented to the user for performing a natural language chat and performing traditional touch best selections of options in connection with the natural language chat.

In an embodiment, the user performs the natural language chat using written text inputted into the sub UI of the container app 134. In an embodiment, the user provides speech inputted via an existing user-operated device's microphone and voice to text features to have speech of the user translated from voice to text and automatically entered into the sub UI of the container app 134. In an embodiment, the user provides speech inputted into a microphone of the user-operated device 130 and the speech or corresponding audio clip is provided directly to the container app 134.

Container app 134 forwards the written text or audio clip provided by the user through the sub UI to AI virtual shopping assistant 113. In an embodiment, AI virtual shopping assistant 113 provides the written text during an AI chat session to chat model 114. In an embodiment, AI virtual shopping assistant 113 provides an audio clip to chat model 114 during the AI chat session. In an embodiment, AI virtual shopping assistant 113 translates the audio clip to text and provides the translated text to chat model 114 during the AI chat session. In an embodiment of the last embodiment, AI virtual shopping assistant 113 uses a voice to text application of machine learning model to translate the audio clip to text.

The content provided by the user during a chat session includes desired items on a shopping list, a recipe, and/or suggestions requested items for an event that the user is planning to have. As an example, the content provided by the user can request for suggested food items for the Super Bowl, items and ingredients required to make stroganoff, and/or specific food items or goods desired by the user during the user's online shopping session with online shopping app 133 through the independent chat session with container app 134. Again, the user provides the content for the chat session via speech or written text in a natural language format of the user's natural spoken or written language.

The chat session is interactive between the user and what the user believes to be a chat model when in fact AI virtual shopping assistant 113 is processing as a proxy in between the user and the chat model 114. AI virtual shopping assistant 113 holds an independent and separate session on behalf of the user with the chat model 114. Furthermore, the initial requests made by the user through the chat session can include multiple simultaneous and different requests. For example, a user provides written text in a natural language via the chat session as follows: “provide me suggested food or food dishes for a party, add 2% milk to my shopping list, add paper plates to my shopping list, and add the ingredients necessary for stroganoff along with the instructions for making the stroganoff.”

In an embodiment, AI virtual shopping assistant 113 provides initial content provided by the user and any subsequent interactive content provided by the user directly to the chat model 114 during the chat session. Responses by the chat model 114 are evaluated by AI virtual shopping assistant 113 before being supplied back to the user via the sub UI of container app 134.

In an embodiment, AI virtual shopping assistant 113 inspect the natural language content provided by the user for key terms or phrases such as “discounts,” “on sale today,” and the like on items and/or ingredients associated with the store. The AI virtual shopping assistant 113 obtains the discount amounts and corresponding item or ingredient identifiers via API 116 from loyalty system 125. AI virtual shopping assistant 113 modifies the user provided natural language content with the discount amounts and corresponding items and/or ingredients. For example, suppose the user provides natural language content as follows during the chat session: “please share dinner ideas using today's store discounts.” AI virtual shopping assistant 113 identifies the discounts and modifies the content as follows “please share dinner ideas using x, y, and z” where x, y, and z are specific items and/or discounts available at the store associated with the online order of the user. AI virtual shopping assistant 113 provides the modified content to the chat bot for a response to the user's request.

AI virtual shopping assistant 113 culls the responses received from the chat bot 114 during the chat session for specific ingredients, brands of items and/or generic requested items. AI virtual shopping assistant 113 uses a product catalogue associated with a retailer or a given store of the user to expand the list into a list of offered and available items and/or ingredients. AI virtual shopping assistant 113 provides the list of available items and/or ingredients to preference manager 115. In an embodiment, AI virtual shopping assistant 113 uses an API 116 to obtain a product catalogue of items and/or ingredients from an inventory system 124 or a transaction system 123 of a retailer for purposes of matching words or speech in responses provided in natural language as output from chat bot 114 to available retailer/store items and/or ingredients.

Preference manager 115 uses a retailer server API 116 to interact with a retailer's loyalty system 125 and inventory system 124 to obtain preferences of the user and to identify existing inventory for the ingredients and/or items for a given store of the retailer that the user identified for placing an online order during the online shopping session with online shopping app 133. Online shopping app 133 provides information relevant to identifying the user's loyalty account and the store for the online order to container app 134 when the container app 134 is initiated based on the user having selected the online chat ordering option from the UI of the online shopping app 133. Container app 134 forwards that information to AI virtual shopping assistant 113 once the user provides the initial content via natural language via the sub UI of container app 134 and AI virtual shopping assistant 113 forwards the information to preference manager 115 during the chat session.

In an embodiment, preference manager 115 maintains a preference profile for the retailer or a given store of the retailer. The preference profile identifies items and ingredients of the retailer or store which is preferably sold to its consumers or users.

In an embodiment, a loyalty account linked to the user includes a preference profile as well as a transaction history of the user. The transaction history identifies brands of items and/or ingredients most frequently purchased by the user. The preference profile includes a variety of user preferences, such as and by way of example only, food allergies, item and/or ingredient brand or type preferences, item and/or ingredient brands or types that the user does not want, etc.

Preference manager 115 evaluates the list of available items and/or ingredients provided by AI virtual shopping assistant 113 in view of existing store inventory for the items, the user's preferences, the user's transaction history, and any retailer or store preferences. Preference manager 115 processes a fuzzy matching algorithm or scoring algorithm to select each item and/or ingredient from the list of available items and/or ingredients based on weights assigned to the transaction history, user preferences, and any retailer or store preferences. The items and/or ingredients with the highest scores are selected and provided by the preference manager 115 back to AI virtual shopping assistant 113.

AI virtual shopping assistant 113 replaces the original items and/or ingredients with the items and/or ingredients returned by chat model 114 in a response to the user during the chat session with the items and/or ingredients returned by the chat model 114. The AI virtual shopping assistant 113 provides the modified response from the chat bot 114 back to container app 134 for presentation to the user during the chat session.

In an embodiment, the preference manager 115 provides a scored list by item and/or ingredient sorted from highest to lowest back to AI virtual shopping assistant 113. In an embodiment, AI virtual shopping assistant 113 tags the replaced items and/or ingredients such that the container app 134 identifies the tags as user selectable UI options within the modified response presented to the user within the sub UI of the container app 134.

In an embodiment, preference manager 115 maintains a list of preferred ingredients and recipes for dishes. The list is maintained based on ratings associated with the dishes. For example, user-rated dishes with corresponding ingredients are obtained based on transaction histories of customers of a given retailer, obtained based on Internet review services (e.g., Google® ratings, etc.), and/or obtained from publicly available social media postings from social media services (e.g., Facebook®, X®, etc.).

In an embodiment, before or after the fuzzy matching or scoring on any available ingredients and recipes for dishes, preference manager restricts the ingredients to a preferred recipe for a given dish. In an embodiment, the ratings associated with preferred ingredients and recipes for dishes are another factor used by preference manager 115 when processing the fuzzy matching or scoring algorithm. In an embodiment, preference manager 115 identifies the recipe provided for a dish in a response from chat bot 114 and restricts the recipe to a highest rating recipe along with its corresponding ingredients such that the list of available items and/or ingredients include the recipe and ingredients of a preferred recipe for a given dish before the list of available items and/or ingredients are provided to preference manager 115.

In an embodiment, the ratings for the recipes of dishes are location based such that a store in a given geographical region is assigned different ratings from a different store in a different geographical region. In an embodiment, the ratings for the recipes of dishes are culturally based such that a store associated with a given ethnicity is assigned different ratings from a different store associated with a different ethnicity or no ethnicity at all.

After the user receives a response to a request made during the chat session with the container app 134 within the sub UI of online shopping app 133, the sub UI presents selectable option and user interface screens for the user to change items, add items, and/or replace items. A search input field of the sub UI allows the user to search for items available at the store where the online order is being placed. Each of the items and/or ingredients are selectable by the user within the sub UI to permit the user to explicitly add items for the online shopping session to a virtualized online cart. The sub UI also allows the user to view the current contents of the cart along with prices associated with the store where the online order is going be placed by the user.

The user can also continue to interact using natural language during the chat session using written sentences and/or speaking in the users native spoken and written language. In an embodiment and once, the user has resolved the items and/or ingredients for the online order with the store, container app sends the items and/or ingredients to online shopping app 133 using an API and the users online shopping session with online shopping app 133 continues to checkout for payment. Online shopping app 133 continues its interaction with a corresponding transaction system 123 to complete the user's online order.

In an embodiment, container app 134 sends identifiers for items and/or ingredients to AI virtual shopping assistant 113, which then sends an online shopping session identifier and the items and/or ingredients to a corresponding transaction system 123. Transaction system 123 sends a notification back to online shopping app, which changes a workflow state to checkout and payment state during the online shopping session of the user for the user's online order.

AI virtual shopping assistant 113 interacts with container app 134 as a user interacts during a chat session. The chat session is a sub user session within the user's online shopping session with the online shopping app 133. Container app 134 provides a sub UI to the user permitting the user to dynamically interact indirectly with chat model 114 through interaction between container app 134 and AI virtual shopping assistant 113. AI virtual shopping assistant 113 interacts directly with chat model 114 during the chat session and modifies responses from the chat model 114 through interaction with preference manager 115. Both AI virtual shopping assistant 113 and container app 134 interact during the chat session based on user selections within the sub UI to assemble an online cart for the user's online order with a given store. Once the user confirms contents of the cart, either container app 134 or AI virtual shopping assistant 113 notify online shopping app 133 or transaction system 123 of the cart's contents for the online shopping session of the user with online shopping app 133. This causes a workflow state of online shopping app 133 for the online order during the user's online shopping session to move to a checkout and payment state. The user interacts with the UI of the online shopping app 133 during the online shopping session to complete payment for the cart and confirm pickup or delivery instructions for the items and/or ingredients purchased by the user.

FIG. 1B is a pictorial diagram depicting an example flow 150 of the system 100, according to an example embodiment. At 151 initiates a request for an online order via the UI of online shopping app 133 and the user selects from the UI a chat session. This initiates container app 134 and establishes a sub or chat session between the user and container app 134. The user provides details of the user's desires and questions via natural language within a sub UI of container app 134.

At 152, container app 134 interacts with AI virtual shopping assistant 113 to provide the natural language input provided by the user. AI virtual shopping assistant 113 provides the natural language input to chat bot 114 and modifies and recipes for dishes, items, and/or ingredients associated with the response from chat bot 114 based on a product catalogue of a store and current inventory of the store to produce an available list of the items and/or ingredients. In an embodiment, AI virtual shopping assistant 113 restricts ingredients and/or recipes for dishes to a highly rated recipe before sending the available list to preference manager 115.

At 153, preference manager 115 performs a fuzzy match to identified preferred items and/or ingredients based on preferences associated with the user and/or the store. In an embodiment, preference manager 115 restricts ingredients and/or recipes for dishes to a highly rates recipe before, after, or during the fuzzy matching. Preference manager 115 returns the preferred items and/or ingredients to AI virtual shopping assistant 113.

At 154, AI virtual shopping assistant 113 interacts with container app 134 to present to the user within the sub UI a modified response generated as output by the chat model to include the preferred items and/or ingredients. The sub UI also includes a list of the items and/or ingredients for the user to view along with store prices for the corresponding items and/or ingredients.

At 155, the user interacts with the sub UI of container app 134 to make additions to, substitutions to, or deletions to any of the preferred items and/or ingredients. At 156, AI virtual shopping assistant 113 interacts with container app 134 to perform the additions, substitutions, and/or deletions from the list. The list and/or any user updated list is maintained as a cart for the user associated with the user's online shopping session with online shopping app 133.

At 157, the user is permitted to continue with the chat session via container app 134 until the user confirms that via the sub UI that the user is ready to checkout for an online order with the online shopping app 133. That is, any of the above referenced processing iterates until the user confirms that the user is ready for checkout.

At 158, AI virtual shopping assistant 113 either provides the user's final list to a transaction system 123 via API 116 or provides the final list to container app 134. In the case where container app 134 receives the final list, container app 134 uses an API to communicate the final list to online shopping app 133. This causes online shopping app 133 to transition to a checkout and payment state within the UI and during interactions of the online shopping session between online shopping app 133 and transaction system 123.

In the case where AI virtual shopping assistant 113 provides the list to transaction system 123 via API 116, transaction system 123 causes the UI and workflow of online shopping app 133 to transition to a checkout and payment state. Online shopping app 133 interacts with transaction system 123 to obtain payment and pickup or delivery instructions from the user to complete the online shopping session.

At 159, user notification processes associated with the store are performed to notify the user that the order is ready for pickup or being delivered. The user receives the order through pickup or delivery thereafter.

Some example user-provided natural language requests that are processed by system 100 are now described. A user provides a natural input request during the chat session as follows” “provide food and beverages for a part with 12 people, please keep under $250;” “provide groceries for the week and a list of recipes that could be used with the ingredients;” provide a gluten free dinner for 4 people;” provide an organic chicken salad recipe for 2 people;” or “please share dinner ideas using today's discounts.” System 100 assembles unrelated products to meet recipe and/or unique conditions set by a user during a chat session, which is not found in other existing solutions available in the industry. This is because system 100 initially inspects a user provided natural language input for keywords or phrases associated with the unrelated products and/or unique conditions to potentially, and when needed, modify the input to account for the unrelated and/or unique conditions based on store inventory, user preferences, store preferences, existing in-store discounts, and/or existing in-store prices. The system 100 than leverages a chat model to return what is needed to satisfy a response to the user. The system 100 can then modify the response and assemble a list or lists of items and/or ingredients for the user to interactively modify. Ultimately, the user is returned to an online shopping order with an online shopping app 133 having a workflow state associated with checkout for payment and pickup or delivery instructions.

System 100 provides transparent and seamless integration into store or retailer-based online shopping apps 133 and corresponding transaction systems 123, inventory systems 124, and loyalty systems 124. As a result, users or customers benefit through reduce time need to plan and shop for meals and the corresponding items and/or ingredients, which enhances the competitiveness of retailers and/or vendors in the online market. Retailers benefit because retailers offering system 100 will be able to satisfy their customers and increase revenues with new customers desiring to eliminate planning and reduce frustration with planning their shopping.

In an embodiment, the workflow and processing associated with the preference manager 115 is subsumed and performed by AI virtual shopping assistant 113. In an embodiment, AI virtual shopping assistant 113, chat bot 114, and preference manager 115 are subsumed into and performed on a given retail server 120. In an embodiment, chat bot 114 is provided via a third-party server accessible to cloud 110 and/or retail server 120.

In an embodiment, the store and/or retailer associated with the user's online order is a third-party meal service that provides ready-made or ingredient-based dishes for meals desired by the user. In an embodiment, the store and/or retailer associated with the user's online order is a grocery store associated with a grocery retailer. In an embodiment, the store and/or retailer associated with the user's online order is a grocery super store, which sells both food items and other non-food items associated with a variety of goods beyond that which a traditional grocery store would sell.

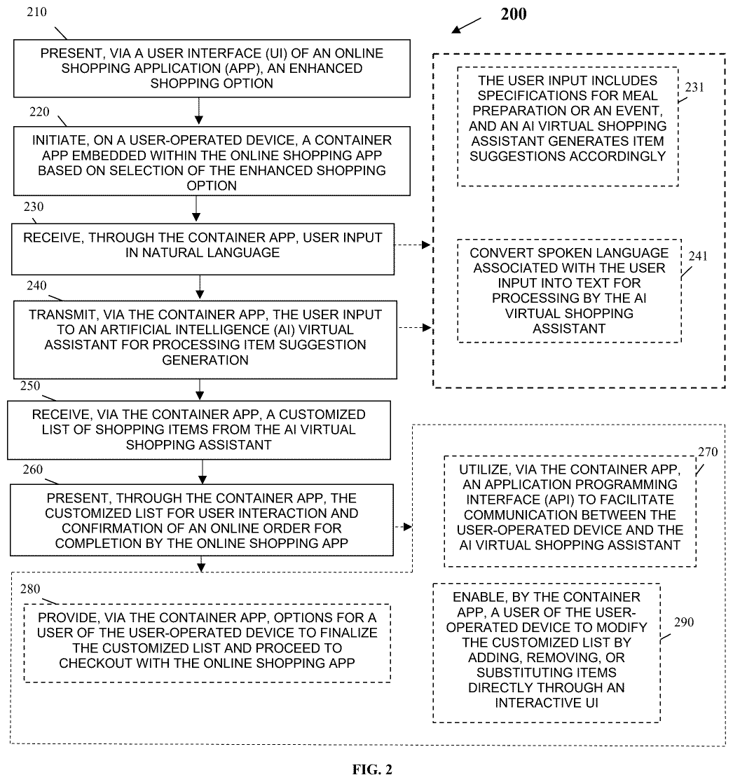

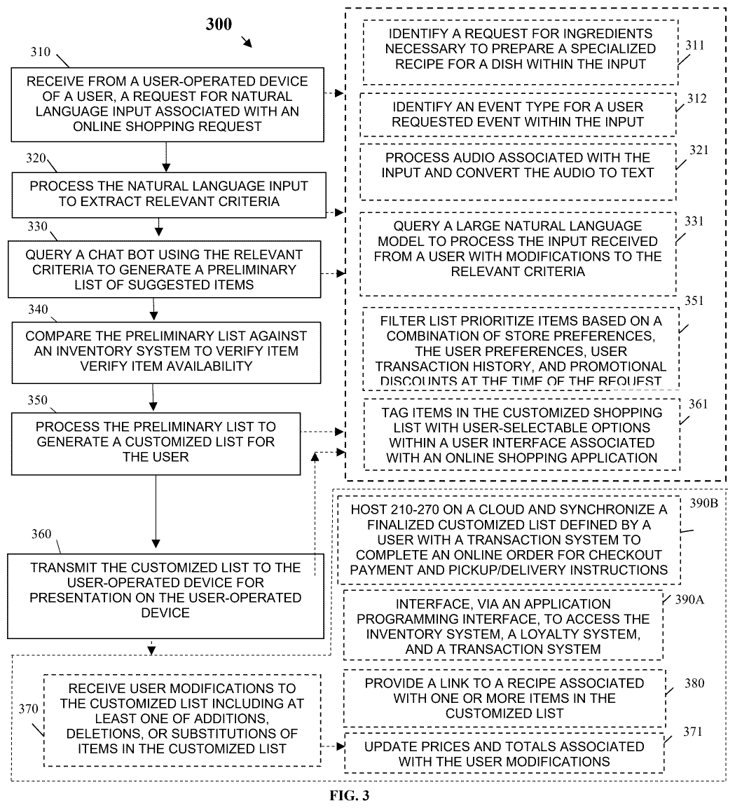

The above-referenced embodiments and other embodiments are now discussed with reference to FIGS. 2 and 3. FIG. 2 is a flow diagram of a method 200 for AI and online shopping integration, according to an example embodiment. The software module(s) that implements the method 200 is referred to as an “online ordering container manager.” The online ordering container manager is implemented as executable instructions programmed and residing within memory and/or a non-transitory computer-readable (processor-readable) storage medium and executed by one or more processors of one or more device(s). The processors that execute the online ordering container manager are specifically configured and programmed for processing the online ordering container manager. The online ordering container manager may have access to one or more network connections during its processing. The network connections can be wired, wireless, or a combination of wired and wireless.

In an embodiment, the device that executes online ordering container manager is user-operated device 130. In an embodiment, the device that executes the online ordering container manager a combination of cloud 110 and user-operated device 130. In an embodiment, the online ordering container manager is any combination of online shopping app 133 and/or container app 134. The online ordering container manager interacts with method 300 discussed below with FIG. 3.

At 210, the online ordering container manager presents, via a user interface of an online shopping app 133, an enhanced shopping option. The enhanced shopping option associated with a natural language chat session between the user and a container app 134 of the online shopping app 133.

At 220, the online ordering container manager initiates on a user-operated device, the container app 134. The container app 134 is embedded within the online shopping app 133. The online ordering container manager initiates the container app 134 based on selection by a user of the enhanced shopping app 133.

At 230, the online ordering container manager receives, through the container app 134, user input in natural language. In an embodiment, at 231, the user input includes specifications for meal preparation or an event. An AI virtual shopping assistant 113 generates item suggestions accordingly based on the user input.

At 240, the online ordering container manager transmits, via the container app 134, the user input to the AI virtual shopping assistant 113 in natural language. In an embodiment, at 241, the online ordering container manager converts spoken language associated with the user input into text for processing by the AI virtual shopping assistant 113.

At 250, the online ordering container manager receives, via the container app 134, a customized list of shopping items from the AI virtual shopping assistant. At 260, the online ordering container manager presents, through the container app 134, the customized list for user interaction and confirmation of an online order for completion by the online shopping app 133.

In an embodiment, at 270, the online ordering container manager utilizes, via the container app 134, an API 116 to facilitate communication between the user-operated device 130 and the AI virtual shopping assistant 113. In an embodiment, at 280, the online ordering container manager provides, via the container app 134, options for a user of the user-operated device to finalize the customized list and proceed to checkout with the online shopping app 133. In an embodiment, at 290, the online ordering container manager enables, via the container app 134, a user of the user-operated device 130 to modify the customized list by adding, removing, or substituting items directly through an interactive UI of the container app 134.

FIG. 3 is a flow diagram of another method 300 for AI and online shopping integration, according to an example embodiment. The software module(s) that implements the method 300 is referred to as an “AI virtual shopping assistant.” The AI virtual shopping assistant is implemented as executable instructions programmed and residing within memory and/or a non-transitory computer-readable (processor-readable) storage medium and executed by one or more processors of one or more devices. The processor(s) of the device(s) that executes the AI virtual shopping assistant are specifically configured and programmed to process the AI virtual shopping assistant. The AI virtual shopping assistant may have access to one or more network connections during its processing. The network connections can be wired, wireless, or a combination of wired and wireless.

In an embodiment, the device that executes the AI virtual shopping assistant is cloud 110. In an embodiment, the device that executes the AI virtual shopping assistant is a retail server 120. In an embodiment, the AI virtual shopping assistant is any combination of or all of AI virtual shopping assistant 113, chat bot 114, preference manager 115, and/or APIs 116.

At 310, AI virtual shopping assistant receives from a user-operated device 130 natural language input. The natural language input received from the user specifies an online shopping request. In an embodiment, the natural language input is provided by a user in the form of questions for item suggestions relevant to an event being planned by the user, items on discount, items below a user-defined price, ingredients associated with a recipe for a dish, and/or items and/or ingredients specified by the user for suggested recipes for a dish that includes the specified items and/or ingredients. In an embodiment, the natural language input is a combination of a one or more questions and directions supplied by the user to add specified items and/or ingredients to a user's virtual online shopping cart.

In an embodiment, at 311, the AI virtual shopping assistant identifies a request for ingredients, which are necessary to prepare a specialized recipe for a dish within the natural language input. That is, the natural language input includes a question and/or instructions for a given recipe and the AI virtual shopping assistant identifies the ingredients necessary for the specialized recipe.

In an embodiment, at 312, the AI virtual shopping assistant identifies an event type for a user requested event within the natural language input. For example, the natural language input includes a question and/or instructions for a dinner with a specific number of dinner guests or a specific type of party with a specific number of guests. The AI virtual shopping assistant also determines typical items and/or ingredients necessary to provide adequately for the guests after a typical or highly rated meal or types of food for the party are identified by the AI virtual shopping assistant.

At 320, the AI virtual shopping assistant processes the natural language input to extract relevant criteria. In an embodiment, the relevant criteria includes conditions set by the user within the natural language input, such as and by way of one example only, the natural language input includes a request for recommendations on dishes, recipes for the dishes, and items and/or ingredients used in the recipes for the dishes using items available at a given store that are currently on discount at the store.

In an embodiment, at 321, the AI virtual shopping assistant processes audio associated with the natural language input. The AI virtual shopping assistant converts the audio clip or file associated with the audio to text and then processes the text in natural language.

At 330, the AI virtual shopping assistant queries a natural language chat bot 114 using the relevant criteria. The AI virtual shopping assistant generates a preliminary list of suggested items based on a natural language output provided by the chat bot 114.

In an embodiment, at 331, the AI virtual shopping assistant queries a large natural language chat model 114 in order to process the natural language input. Before providing the natural language input to the large natural language chat model, the AI virtual shopping assistant performs modifications on or to the relevant criteria.

At 340, the AI virtual shopping assistant compares the preliminary list against an inventory system 123 to verify item availability. That is, the AI virtual shopping assistant ensures the items and/or ingredients necessary to satisfy the user's natural language input are currently in-stock and available for purchase at a given store associated with an online order being placed by the user during an online shopping session.

At 350, the AI virtual shopping assistant processes the preliminary list to generate a customized list based on 350. The customized list aligned with the user's natural language input received at 310.

In an embodiment, at 351, the AI virtual shopping assistant filters the preliminary list to align with store or user preferences and to align with the inventory system 123. The AI virtual shopping assistant also prioritizes, or sorts items of the preliminary list based on a combination of store preferences, user preferences, user transaction history, and/or promotional discounts available at the time of the online shopping request during the filtering of 350. The AI virtual shopping assistant processes a fuzzy matching algorithm that weights and scores the items of the preliminary list based on the combination.

At 360, the AI virtual shopping assistant transmits the customized list to the user-operated device 130 for presentation on the user-operated device 130 and for user review and confirmation. In an embodiment, at 361, the AI virtual shopping assistant tags items in the customized shopping list with user-selectable options within a user interface associated with an online shopping app 133.

In an embodiment, at 370, the AI virtual shopping assistant receives user modifications to the customized list. The modifications include at least one additions, deletions, or substitutions of items in the customized list. The AI virtual shopping assistant interacts with the user to perform the modifications until the user indicates a virtualized cart associated with the customized list is finalized and the ready is ready to proceed to checkout for payment and/or pickup or delivery instructions. In an embodiment, at 371, the AI virtual shopping assistant updates prices and totals associated with items in the customized list based on the user modifications.

In an embodiment, at 380, the AI virtual shopping assistant provides a link to a recipe associated with one or more items in the customized list. That is, the AI virtual shopping assistant provides a description for a dish along with a link for the user to view a given recipe associated with the dish.

In an embodiment, at 390A, the AI virtual shopping assistant interfaces, via an API 116, to access the inventory system 124, a transaction system 123, and a loyalty system 125. In an embodiment, at 390B, the AI virtual shopping assistant is hosted on a cloud 110 and synchronizes a finalized customized list interactively defined by the user with a transaction system 123 to complete an online order for checkout payment and pickup or delivery instructions supplied subsequently by the user during a checkout.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
presenting, via a user interface (UI) of an online shopping application, an enhanced shopping option;
initiating, on a user-operated device, a container application embedded within the online shopping application based on selection of the enhanced shopping option;
receiving, through the container application, a user input in natural language;
transmitting, via the container application, the user input to an artificial intelligence (AI) virtual shopping assistant for processing item suggestion generation;
receiving, via the container application, a customized list of shopping items from the AI virtual shopping assistant; and
presenting, through the container application, the customized list for user interaction and confirmation of an online order for completion by the online shopping application.

2. The method of claim 1, wherein, and for the initiating, the user input includes specifications for meal preparation or an event, and the AI virtual shopping assistant generates item suggestions accordingly.

3. The method of claim 1, wherein transmitting further includes converting spoken language associated with the user input into text for processing by the AI shopping assistant.

4. The method of claim 1, further comprising, utilizing, via the container application, an application programming interface (API) to facilitate communication between the user-operated device and the AI virtual shopping assistant.

5. The method of claim 1, further comprising providing, via the container application, options for a user of the user-operated device to finalize the customized list and proceed to checkout with the online shopping application.

6. The method of claim 1, further comprising enabling, via the container application, a user of the user-operated device to modify the customized list by adding, removing, or substituting items directly through an interactive UI.

7. A method, comprising:
receiving, from a user-operated device of a user, a request for natural language input associated with an online shopping request;
processing the natural language input to extract relevant criteria;
querying a chat bot using the relevant criteria to generate a preliminary list of suggested items;
comparing the preliminary list against an inventory system to verify item availability;
processing the preliminary list to generate a customized list for the user; and
transmitting the customized list to the user-operated device for presentation on the user-operated device.

8. The method of claim 7, further comprising receiving user modifications to the customized list including at least one of additions, deletions, or substitutions of items in the customized list.

9. The method of claim 8, further comprising updating prices and totals associated with the user modifications.

10. The method of claim 7, further comprising interfacing, via application programming interfaces (APIs), to access the inventory system, a loyalty system, and a transaction system.

11. The method of claim 7, further comprising providing, a link to a recipe associated with one or more items in the customized shopping list.

12. The method of claim 7, further comprising hosting the method on a cloud and synchronizing a finalized customized list defined by a user with a transaction system to complete an online order with checkout payment and pickup or delivery instructions.

13. The method of claim 7, wherein receiving further includes identifying a request for ingredients necessary to prepare a specified recipe for a dish within the natural language input.

14. The method of claim 7, wherein receiving further includes identifying an event type for a user requested event within the natural language input.

15. The method of claim 7, wherein processing the natural language input to extract the relevant criteria further includes processing audio associated with the natural language input and converting the audio to text.

16. The method of claim 7, wherein querying further includes querying a large natural language model to process the natural language input received from a user with modifications to the relevant criteria.

17. The method of claim 7, wherein processing the preliminary list further includes filtering the preliminary list to align with store or user preferences and prioritizing items based on a combination of the store preferences, the user preferences, user transaction history, and promotional discounts available at a time of the online shopping request.

18. The method of claim 7, wherein transmitting further includes tagging items in the customized shopping list with user-selectable options within a user interface associated with an online shopping application.

19. A system, comprising:
an artificial intelligence (AI) virtual shopping assistant configured to process a user input and generate a list of suggested shopping items based on the user input, wherein the user input provided by a user-operated device configured to receive the user input, wherein the user input is provided in natural language;
a container application embedded within an online shopping application on the user-operated device, the container application configured to facilitate interaction between a user of the user-operated device and the AI virtual shopping assistant; and
a user interface (UI) provided by the container application, the UI configured to present the list of suggested shopping items to the user for review and modification, wherein once the user confirms a final list, the final list is provided to the online shopping application for user checkout, payment, and user pickup or delivery instructions.

20. The system of claim 19, wherein the AI virtual shopping assistant is further configured to interface with a retail server to access real-time inventory data and user or store preference data to refine the list based on availability and the user or store preferences.
